(19) United States
(12) Patent Application Publication
(10) Pub. No.: US 2017/0273118 A1
(43) Pub. Date: Sep. 21, 2017

(54) BASE STATION DEVICE FOR CONTROLLING AUTOMATIC DRIVING,MOBILE COMMUNCATION SYSTEM FOR CONTROLLING AUTOMATIC DRIVING,AND CONTROL,METHOD FOR MOBILE CONTROL SYSTEM FOR CONTROLLING AUTOMATIC DRIVING

(71) Applicant: FUJITSU LIMITED, Kawasaki-shi (JP)

(72) Inventors: Noboru Hasegawa, Oota (JP); Kazunari Kobayashi, Yokohama (JP); Satoshi Ueda, Yokohama (JP); YOSHIO MIURA, Yokohama (JP); Katsuyuki Masuda, Yokohama (JP); Yuya Murakami, Yokohama (JP); Takeshi YONEKURA, Kawasaki (JP); YOSHIO TAMURA, Yokohama (JP); Michiaki MORI, Yokohama (JP); Koki TAKAHASHI, Chofu (JP)

(73) Assignee: FUJITSU LIMITED, Kawasaki-shi (JP)

(21) Appl. No.: 15/434,033

(22) Filed: Feb. 15, 2017

(30) Foreign Application Priority Data
Mar. 18, 2016 (JP) 2016-056036

(51) Int. Cl. H04W 76/02

(52) U.S. Cl. CPC H04W 76/02; H04W 84/005

(57) ABSTRACT

A base station device receives a signal for connection establishment between a terminal device and the base station device from the terminal device and performs a series of processes for the connection establishment. A reception unit receives the signal for the connection establishment transmitted from the terminal device. When predetermined information is stored in the signal for the connection establishment received by the reception unit, an emergency-information processing unit acquires the predetermined information. A transmission unit transmits a notification signal including the predetermined information acquired by the emergency-information processing unit to another terminal device other than the terminal device.

### CROSS-REFERENCE TO RELATED APPLICATION

This application is based upon and claims the benefit of priority of the prior Japanese Patent Application No. 2016-056036, filed on Mar. 18, 2016, the entire contents of which are incorporated herein by reference.

### FIELD

The embodiments discussed herein are related to a base station device, a terminal device, a mobile communication system, and a control method for a mobile control system.

### BACKGROUND

In recent years, an assist function of assisting driving of a vehicle based on information acquired by sensors attached to the vehicle has been proposed for automatic driving of a vehicle. The assist function includes, for example, an automatic braking system. Further, such a technique has been proposed that pieces of information of respective vehicles such as driving information acquired by a sensor are consolidated in a data server via a mobile communication network, and information for assisting driving is fed back to the vehicle and used to support driving. The information for assisting driving includes, for example, congestion information and construction information of a road where the vehicle is being driven.

Further, by registering a destination, a global positioning system (GPS) and an acceleration operation can be controlled based on information from various sensors mounted on a vehicle, and research and development for realizing autonomous automatic driving of a vehicle by itself have been carried out. However, in order to realize efficient and complete automatic driving of one vehicle, it is desired to perform analysis and judgment of not only information from various sensors that can be collected by a vehicle single body but also information of other vehicles, surrounding traffic conditions, and the like. Many communication methods have been proposed for vehicle-to-vehicle communication and road-to-vehicle communication. In order to realize complete automatic driving, information sharing and real-time communication for information sharing with respect to various vehicles are desired in order to feed back the information to the vehicles.

Conventionally, when information from a certain terminal device belonging to a mobile communication system is to be shared and utilized with other terminal devices, pieces of data are generally collected in a dedicated database server and information is distributed to respective terminal devices. As another information sharing method, there is a method of realizing broadcast communication between terminal devices by repeating one-to-one direct communication between terminal devices without using a network of the mobile communication system.

There is also a conventional technique in which a terminal device that has received information broadcasted from a base station device transfers the received information to other terminal devices.

However, in the conventional communication via a data server, a delay occurs in a complicated network route, thereby making it difficult to improve the performance of automatic driving. Further, in the communication for broadcasting information by vehicle-to-vehicle communication, notification to a remote vehicle takes time because of passing through a plurality of vehicles to cause delay, thereby making it difficult to improve the performance of automatic driving.

Even in the conventional technique that transfers information broadcasted from the base station device to other terminal devices, there is still a possibility of occurrence of a delay because of a delay due to broadcasting and repeating vehicle-to-vehicle communication, and hence, it is difficult to improve the performance of automatic driving.

### SUMMARY

According to an aspect of an embodiment, a base station device that receives a signal for connection establishment between a terminal device and the base station device from the terminal device and performs series of processes for the connection establishment, the base station device includes: a reception unit that receives the signal for the connection establishment transmitted from the terminal device; an acquisition unit that acquires predetermined information, when the predetermined information is stored in the signal for the connection establishment received by the reception unit; and a transmission unit that transmits a notification signal including the predetermined information acquired by the acquisition unit to at least another terminal device other than the terminal device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic configuration diagram of a mobile communication system;

FIG. 2 is a block diagram of a base station device;

FIG. 3 is a diagram illustrating an example of contents of notification information;

FIG. 4 is a diagram illustrating an example of a format of an RRC connection request;

FIG. 5 is a diagram illustrating an example of a format of an RRC connection reject;

FIG. 6 is a block diagram of a terminal device;

FIG. 7 is a sequence diagram representing an outline of a notification process of emergency information by a mobile communication system according to an embodiment;

FIG. 8 is a sequence diagram representing details of a process performed by a base station device in notification of emergency information;

FIG. 9 is a sequence diagram representing details of a process performed by a terminal device in notification of emergency information;

FIG. 10 is a hardware configuration diagram of a base station device; and

FIG. 11 is a hardware configuration diagram of a terminal device.

### DESCRIPTION OF EMBODIMENT(S)

Preferred embodiments of the present invention will be explained with reference to accompanying drawings. The base station device, the terminal device, the mobile communication system, and the control method for a mobile control system disclosed in the present application are not limited to the embodiments.

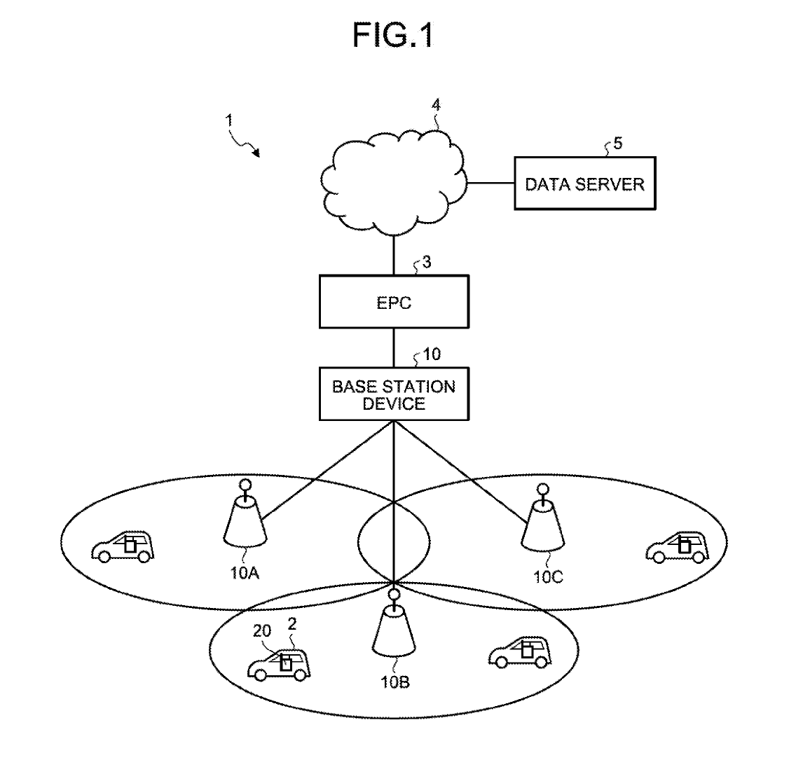

FIG. 1 is a schematic configuration diagram of a mobile communication system. A mobile communication system 1 according to the present embodiment includes an evolved packet core (EPC) 3, the Internet 4, a data server 5, and a base station device 10.

The EPC 3 functions as an interface with the base station device 10 in a core network. The EPC 3 includes, for example, a mobility management entity (MME), a serving gateway (S-GW), a packet data network gateway (P-GW), and a policy and charging rules function (PCRF).

The EPC 3 is connected to the Internet 4. The EPC 3 performs communication with the data server 5 via the Internet 4.

The base station device 10 has radio devices 10A to 10C. A vehicle 2 mounted with a terminal device 20 is present in each cell of the radio devices 10A to 10C. For example, the base station device 10 transmits and receives data to and from the terminal device 20 of the vehicle 2 present in the cell of the radio device 10A via the radio device 10A. In FIG. 1, one base station device 10 is illustrated. Actually, however, a plurality of base station devices 10 are present.

The base station device 10 is connected to the EPC 3. The base station device 10 communicates with the data server 5 via the EPC 3. The base station device 10 also communicates with another base station device 10 via the EPC 3. The base station device 10 can have an inter-base-station communication interface that connects with other base station devices 10, and can communicate with another base station device 10 by using the inter-base-station communication interface.

The vehicle 2 includes a terminal device 20. The terminal device 20 mounted on the vehicle 2 is connected to the base station device 10 by using a radio device having a cell in which the vehicle 2 is present, among the cells of the radio devices 10A to 10C of the base station device 10. The terminal device 20 communicates with other terminal devices 20 via the connected base station device 10 and the EPC 3.

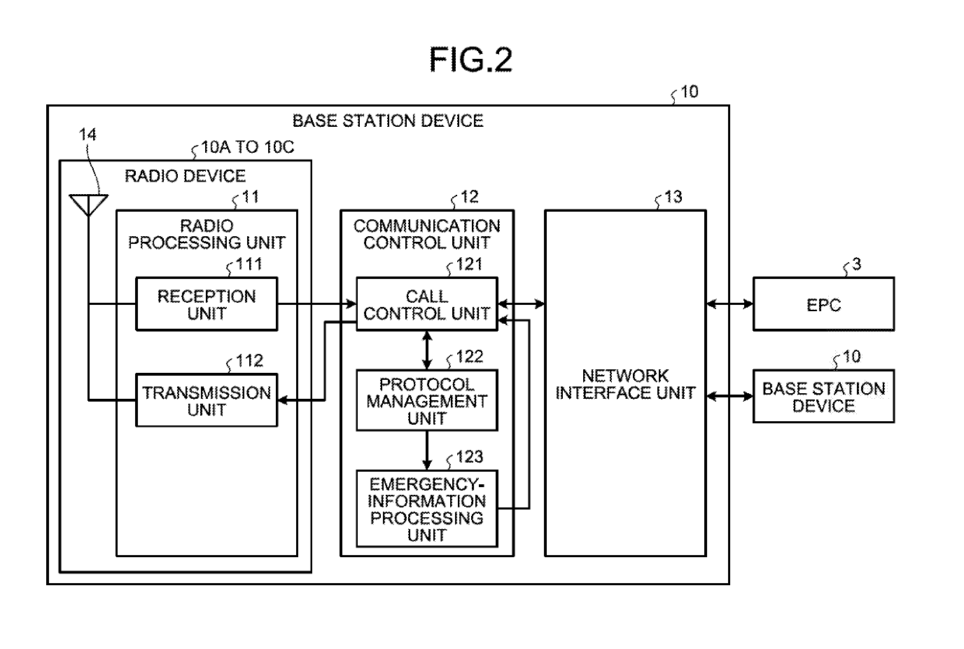

Details of the base station device 10 that performs notification of emergency information in the mobile communication system 1 will be described next with reference to FIG. 2. FIG. 2 is a block diagram of the base station device.

As illustrated in FIG. 2, the base station device 10 includes a radio processing unit 11, a communication control unit 12, and a network interface unit 13.

The radio processing unit 11 is an interface for radio communication with the terminal device 20, and corresponds to the radio devices 10A to 10C. The radio processing unit 11 includes a reception unit 111 and a transmission unit 112. In the present embodiment, the radio devices 10A to 10C are separated from the system including the communication control unit 12 and the network interface unit 13 and installed in another place. However, the radio devices 10A to 10C can be arranged in the same place therewith as one system.

The reception unit 111 receives a radio signal transmitted from the terminal device 20 via an antenna 14. The reception unit 111 generates a baseband signal by demodulating the received signal and changing the frequency of the received signal. The reception unit 111 also decodes the generated baseband signal. Thereafter, the reception unit 111 outputs the decoded baseband signal to a call control unit 121.

The reception unit 111 receives a connection request signal including an RRC connection request being a radio-resource-control connection request from the terminal device 20. The reception unit 111 extracts a Layer (L)3 signal including a radio resource control (RRC) layer from the received connection request signal to acquire the RRC connection request. The reception unit 111 outputs the RRC connection request to the call control unit 121.

The transmission unit 112 receives an input of a paging request from the call control unit 121. The transmission unit 112 also receives an input of the baseband signal from the call control unit 121. The transmission unit 112 encodes the acquired baseband signal. The transmission unit 112 modulates the encoded baseband signal to generate a radio signal by changing the frequency. Thereafter, the transmission unit 112 performs paging and transmits the generated radio signal to a destination terminal device 20 via the antenna 14.

When emergency information is notified, the transmission unit 112 receives an input of an RRC connection reject being a connection reject notification from the call control unit 121, as a response with respect to the RRC connection request. The transmission unit 112 incorporates the L3 signal including the RRC connection reject in a connection-reject notification signal. The transmission unit 112 transmits the connection-reject notification signal to the terminal device 20 being a transmission source of the RRC connection request, to notify the terminal device 20 of the RRC connection reject.

The transmission unit 112 receives an input of a paging request for transmission of the notification information including the emergency information incorporated therein from the call control unit 121. The transmission unit 112 incorporates the L3 signal including the notification information including the emergency information incorporated therein in a notification signal. The transmission unit 112 transmits the notification signal to the respective terminal devices 20 to transmit the notification information including the emergency information incorporated therein to the respective terminal devices 20.

The call control unit 121 uses preset call setting to execute control of the entire call processing with regard to radio communication and voice communication, such as control of communication resources to be used for communication with the terminal devices 20. The call control unit 121 performs connection management between the base station device 10 and the terminal devices 20 such as handover of the terminal device 20. Further, the call control unit 121 terminates an L3 message such as a measurement report.

The call control unit 121 receives a signal input from the reception unit 111. The call control unit 121 outputs a signal to be transmitted to the EPC 3 or other base station devices 10 to the network interface unit 13. The call control unit 121 also receives a signal input from the EPC 3 or other base station devices 10. The call control unit 121 outputs a signal to be transmitted to the terminal device 20 to the transmission unit 112.

The call control unit 121 receives an input of the RRC connection request from the reception unit 111. The call control unit 121 recognizes that the received signal is an RRC connection request. When having recognized that the received signal is an RRC connection request, the call control unit 121 transmits the RRC connection request to a protocol management unit 122.

Thereafter, the call control unit 121 receives an input of the RRC connection reject as a response to the RRC connection request from the protocol management unit 122. The call control unit 121 outputs the RRC connection reject to the transmission unit 112.

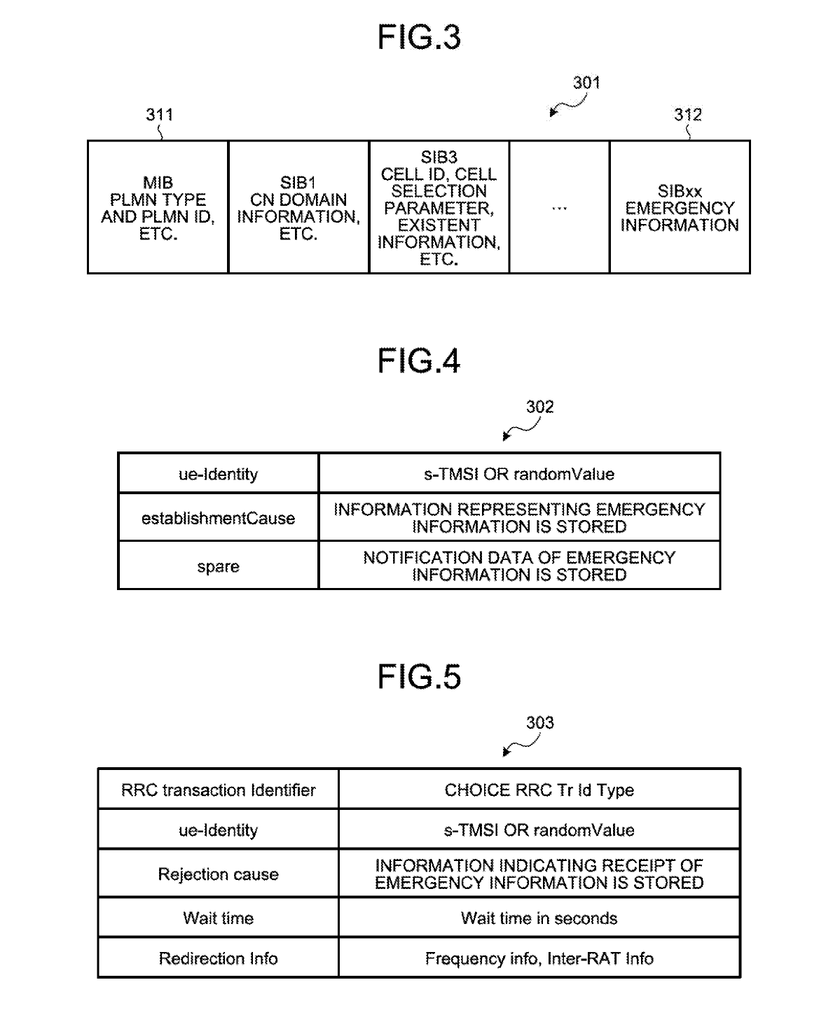

The call control unit 121 receives an input of a transmission request of the notification information together with the emergency information from an emergency-information processing unit 123. FIG. 3 is a diagram illustrating an example of contents of the notification information. In the mobile communication system 1 according to the present embodiment, as illustrated in FIG. 3, a system information block (SIB) 312 representing the emergency information is newly defined.

The call control unit 121 stores information indicating presence of the SIB of the emergency information in a MIB 311 of the notification information having a format 301 illustrated in FIG. 3. The call control unit 121 also stores the emergency information in the SIB 312. Thus, the call control unit 121 incorporates the emergency information in the notification information. The call control unit 121 outputs a paging request for transmission of the notification information including the emergency information incorporated therein to the transmission unit 112.

When connection with the terminal device 20 is to be established, the protocol management unit 122 determines the contents of the signal received from the terminal device 20. The protocol management unit 122 then generates a signal according to the protocol depending on the determined contents of the signal. Specifically, the protocol management unit 122 generates an RACH response including transmission timing and the like with respect to an RACH preamble transmitted from the terminal device 20 and transmits the RACH response to the call control unit 121. Upon reception of the RRC connection request, when connection is to be permitted, the protocol management unit 122 transmits an RRC connection setup to the call control unit 121. Thereafter, the protocol management unit 122 receives an RRC connection complete to complete establishment of connection with the terminal device 20. When the connection is to be rejected, the protocol management unit 122 transmits an RRC connection reject to the call control unit 121.

For example, the protocol management unit 122 receives an input of the RRC connection request from the call control unit 121. The RRC connection request is represented, for example, in a format 302 illustrated in FIG. 4. FIG. 4 is a diagram illustrating an example of a format of the RRC connection request. As illustrated in FIG. 4, the RRC connection request has a user equipment (ue)-Identity region, an establishmentCause region, and a spare region. In the ue-Identity region, temporary mobile subscriber identity (s-TMSI) or randomValue is stored as a temporary number for identifying the terminal device 20 as the transmission source. The establishmentCause region stores a reason of the connection request. In the mobile communication system 1 according to the present embodiment, a reason “emergency information” is newly added as the reason of the connection request. When the emergency information is to be notified, information representing the emergency information is stored in the establishmentCause region. In the spare region, notification data of the emergency information is stored when the emergency information is to be notified.

The protocol management unit 122 confirms the establishmentCause region in the acquired RRC connection request, to determine whether information representing the emergency information is stored therein. If information representing the emergency information is not stored therein, the protocol management unit 122 performs normal processing.

On the other hand, if information representing the emergency information is stored therein, the protocol management unit 122 transmits the RRC connection request to the emergency-information processing unit 123. Further, the protocol management unit 122 generates an RRC connection reject.

FIG. 5 is a diagram illustrating an example of a format of the RRC connection reject. The RRC connection reject is represented, for example, in a format 303 illustrated in FIG. 5. The RRC connection reject has respective regions of RRC transaction identifier, ue-Identity, Rejection cause, Wait time, and Redirection Info. The RRC transaction identifier region is a region for storing information for uniquely identifying a transaction. In the ue-Identify region, a value used in the RRC connection request is stored. The Rejection cause region is a region in which the reason of connection reject is stored. In the mobile communication system 1 according to the present embodiment, as the reason of connection reject, a reason of “reception of emergency information” is newly added. In a case of notification of emergency information, information indicating that emergency information has been received is stored in the Rejection cause region. Wait time until the next processing is stored in the wait time region. Frequency information and information of other networks are stored in the Redirection Info region.

The protocol management unit 122 stores information indicating that the emergency information has been received in the Rejection cause region in the RRC connection reject illustrated in FIG. 5. The protocol management unit 122 outputs the generated RRC connection reject to the call control unit 121. Thus, the protocol management unit 122 ends a connection sequence by transmitting the RRC connection reject, thereby preventing retransmission of the RRC connection request by the terminal device 20.

The emergency-information processing unit 123 receives an input of the RRC connection request from the protocol management unit 122. The emergency-information processing unit 123 acquires the emergency information indicated by the notification data stored in the spare region of the RCC connection request. The emergency-information processing unit 123 transmits a transmission request of the notification information together with the acquired emergency information to the call control unit 121. The emergency-information processing unit 123 corresponds to an example of an “acquisition unit”.

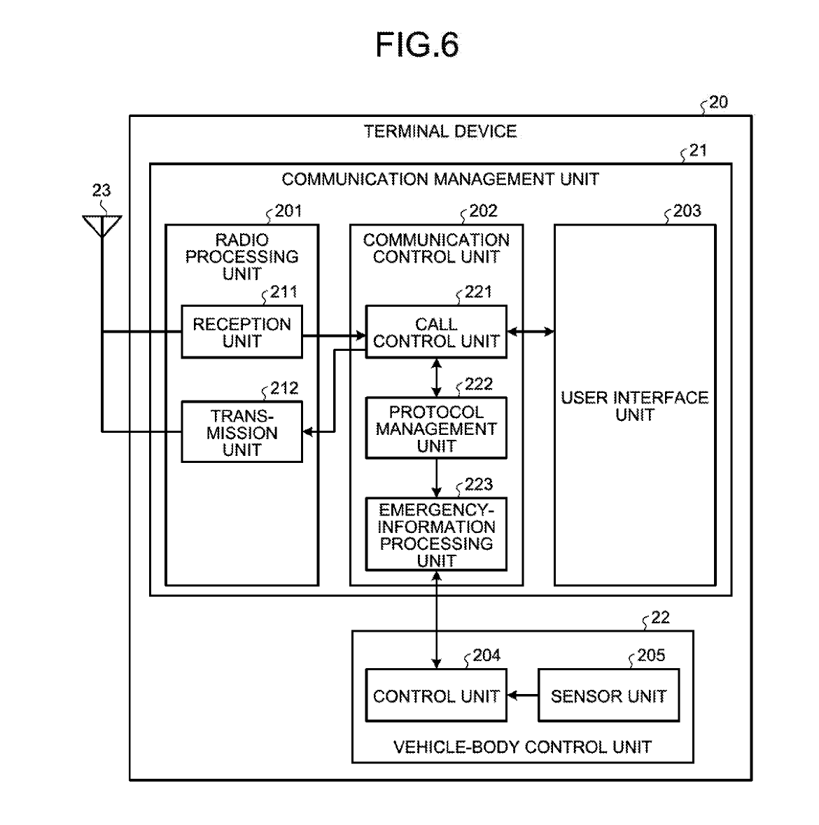

Details of the terminal device 20 that performs notification of emergency information and reception of notification information in the mobile communication system 1 is described next with reference to FIG. 6. FIG. 6 is a block diagram of the terminal device.

The terminal device 20 performs acquisition of the state of the vehicle 2, executes operation control of the vehicle 2, and performs notification of emergency information to the base station device 10 and acquisition of notification information from the base station device 10. The terminal device 20 includes a communication management unit 21 and a vehicle-body control unit 22.

The vehicle-body control unit 22 acquires the state of the vehicle 2 and controls the operation of the vehicle 2. The vehicle-body control unit 22 includes a control unit 204 and a sensor unit 205.

The sensor unit 205 monitors an operation state of the vehicle 2 such as a brake operation and the speed of the vehicle 2, and acquires operation information of the vehicle. The sensor unit 205 outputs the operation information of the vehicle 2 to the control unit 204. For example, the sensor unit 205 outputs pieces of information such as a braking position, a time, a traveling speed, and a brake force to the control unit 204 as operation information of the vehicle 2.

The control unit 204 receives an input of the operation information of the vehicle 2 from the sensor unit 205. The control unit 204 then determines whether to execute control. When determining to execute control, the control unit 204 controls the operation of the vehicle 2 depending on the operation information of the vehicle 2.

The control unit 204 receives an input of information of an inter-vehicular distance and speed information of the vehicle 2 from the sensor unit 205. When the inter-vehicular distance is shorter than a predetermined distance and the speed is equal to or higher than a predetermined speed, the control unit 204 decides to execute brake control. The control unit 204 then controls the vehicle 2 to put on the brake.

When autonomous control has been executed, the control unit 204 sends a notification of autonomous control to an emergency-information processing unit 223. The control unit 204 can add information acquired from the sensor unit 205 in addition to the operation information of autonomous control.

In the present embodiment, when autonomous control has been executed, the control unit 204 always sends a notification to the emergency-information processing unit 223 to start notification of the emergency information. However, the control unit 204 can determine whether to send a notification of the emergency information separately from execution of the autonomous control. For example, the control unit 204 can determine whether to notify the emergency-information processing unit 223 of the emergency information based on a control result of the vehicle 2, and can notify the emergency-information processing unit 223 of the emergency information based on the determination result. For example, when the control unit 204 puts the brake on the vehicle 2 harder than a predetermined force by autonomous control, the control unit 204 can send a notification of the emergency information to the emergency-information processing unit 223.

Further, for example, the control unit 204 can decide execution of notification of emergency information by using acquired operation information of the vehicle 2, independently of execution of autonomous control. For example, when a traveling speed acquired from the sensor unit 205 exceeds a predetermined speed and a brake force exceeds a predetermined brake force, the control unit 204 can send a notification of the emergency information to the emergency-information processing unit 223.

Further, when notification information including emergency information incorporated therein transmitted by another terminal device 20 is delivered, the control unit 204 receives an input of information of control to be executed from the emergency-information processing unit 223. The control unit 204 executes the instructed control with respect to the vehicle 2.

The communication management unit 21 transmits the emergency information and receives the notification information. The communication management unit 21 includes a radio processing unit 201, a communication control unit 202, and a user interface unit 203.

The user interface unit 203 has a liquid crystal screen or the like having a touch pad function. Upon reception of an input by an operation of an operator, the user interface unit 203 outputs the input information to a call control unit 221. The user interface unit 203 displays information input from the call control unit 221 on the liquid crystal screen or the like.

The radio processing unit 201 is an interface in radio communication with the base station device 10. The radio processing unit 201 includes a reception unit 211 and a transmission unit 212.

The reception unit 211 receives a radio signal sent out from the base station device 10 via an antenna 23. The reception unit 211 changes the frequency of the received signal by demodulating the received signal to generate a baseband signal. The reception unit 211 then decodes the generated baseband signal. Thereafter, the reception unit 211 outputs the decoded baseband signal to the call control unit 221.

In a case of notification of emergency information, the reception unit 211 receives an RACH response from the base station device 10. The reception unit 211 outputs the received RACH response to the call control unit 221. Thereafter, the reception unit 211 receives an RRC connection reject being a signal rejecting establishment of connection from the base station device 10. The reception unit 211 then outputs the received RRC connection reject to the call control unit 221.

The reception unit 211 also receives notification information including emergency information incorporated therein from the base station device 10. The reception unit 211 outputs the received notification information to the call control unit 221.

The transmission unit 212 receives an input of the baseband signal from the call control unit 221. The transmission unit 212 then encodes the acquired baseband signal. The transmission unit 212 modulates the encoded baseband signal to change the frequency thereof, thereby generating a radio signal. Thereafter, the transmission unit 212 transmits the generated radio signal to the base station device 10 via the antenna 23.

When the emergency information is notified, the transmission unit 212 receives a transmission request of an RACH preamble from the call control unit 221. The transmission unit 212 generates and transmits an RACH preamble to the base station device 10. The transmission unit 212 receives an input of a transmission request of an RRC connection request from the call control unit 221. The transmission unit 212 transmits the acquired RRC connection request to the base station device 10.

The call control unit 221 executes control of the entire call processing associated with radio communication, such as control of communication resources to be used for communication with the base station device 10 by using preset call setting. The call control unit 221 receives an input of a signal received from the base station device 10 from the reception unit 211. The call control unit 221 performs processing with respect to the received signal and provides information to an operator by using the user interface unit 203.

The call control unit 221 receives an input of a transmission request of the RRC connection request from a protocol management unit 222. The call control unit 221 determines the state of the terminal device 20. When the terminal device 20 can perform communication, the call control unit 221 performs a radio connection sequence. Specifically, the call control unit 221 transmits a transmission request of the RACH preamble to the transmission unit 212. Thereafter, upon reception of the RACH preamble from the transmission unit 212, the call control unit 221 outputs a transmission request of the RRC connection request to the transmission unit 212.

Thereafter, the call control unit 221 receives an input of an RRC connection reject from the reception unit 211, as a response to the RRC connection request. The call control unit 221 confirms the Rejection cause region in the RRC connection reject to ascertain that reception of the emergency information is complete. The call control unit 221 ends the connection sequence for notifying the emergency information.

The call control unit 221 receives an input of the notification information including the emergency information incorporated therein from the reception unit 211. The call control unit 221 outputs the acquired notification information to the protocol management unit 222.

The protocol management unit 222 receives a transmission request of the emergency information from the emergency-information processing unit 223. At this time, the protocol management unit also receives an input of notification data notified as the emergency information from the emergency-information processing unit 223.

The protocol management unit 222 generates an RRC connection request. Specifically, the protocol management unit 222 stores information representing the emergency information in the establishmentCause region in the RRC connection request illustrated in FIG. 4. Further, the protocol management unit 222 stores notification data of the emergency information in the spare region in the RRC connection request illustrated in FIG. 4. Thereafter, the protocol management unit 222 transmits the generated RRC connection request to the call control unit 221.

The protocol management unit 222 receives an input of the notification information including the emergency information incorporated therein from the call control unit 221. The protocol management unit 222 then confirms the MIB 311 illustrated in FIG. 3 in the acquired notification information to determine whether there is the SIB 312 in which the emergency information is stored.

When there is the SIB 312 in which the emergency information is stored, the protocol management unit 222 determines whether the emergency information has been transmitted from the terminal device 20 mounted with the own protocol management unit 222. When the emergency information has been transmitted from the terminal device 20 mounted with the own protocol management unit 222, the protocol management unit 222 ends the process associated with acquisition of the emergency information. On the other hand, if the source of the emergency information is another terminal device 20, the protocol management unit 222 acquires notification data from the SIB 312 illustrated in FIG. 3 in the acquired notification information. The protocol management unit 222 outputs the extracted notification data to the emergency-information processing unit 223.

The emergency-information processing unit 223 acquires notification of autonomous control from the control unit 204. In the notification of autonomous control, for example, a time when the brake is suddenly applied, a traveling direction, a traveling speed, and a brake force are stored. The emergency-information processing unit 223 generates notification data to be notified as emergency information from the acquired notification of autonomous control. Thereafter, the emergency-information processing unit 223 outputs a transmission request of the emergency information together with the notification data to the protocol management unit 222.

The emergency-information processing unit 223 receives an input of notification data being the emergency information from the call control unit 221. The emergency-information processing unit 223 decides control to be executed based on the acquired notification data. The emergency-information processing unit 223 then notifies the control unit 204 of the control to be executed. The emergency information corresponds to an example of “predetermined information”. The emergency-information processing unit 223 corresponds to an example of a “signal transmission unit”.

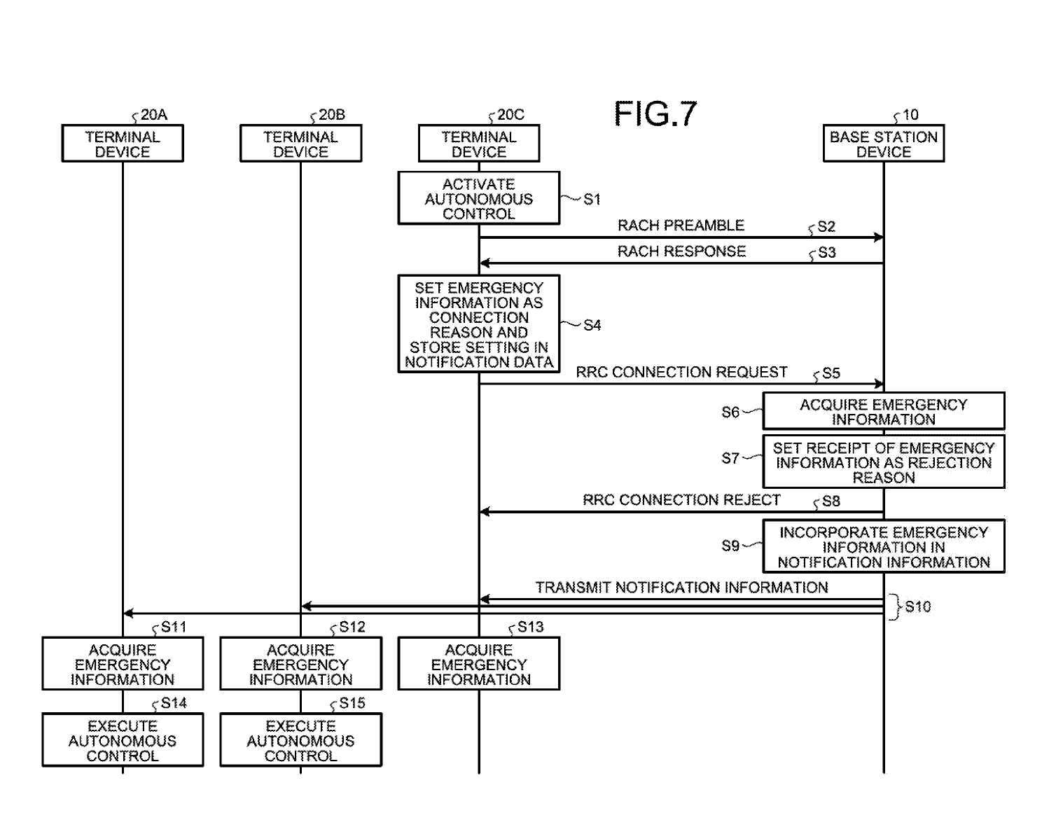

An outline of a notification processing flow of emergency information by the mobile communication system 1 is described next with reference to FIG. 7. FIG. 7 is a sequence diagram representing an outline of a notification process of emergency information by the mobile communication system according to the embodiment. A case where there are terminal devices 20A to 20C as the terminal device 20, and the terminal device 20C among the devices issues emergency information is described here. In FIG. 7, the name illustrated in an upper part of a longitudinal axis is the device that performs an operation corresponding to the longitudinal axis, and the longitudinal axis represents passage of time as heading downward.

In the vehicle 2 mounted with the terminal device 20C, autonomous control is activated (Step S1).

The terminal device 20C transmits an RACH preamble to the base station device 10 (Step S2).

The base station device 10 receives the RACH preamble from the terminal device 20C. The base station device 10 transmits an RACH response to the terminal device 20C (Step S3).

The terminal device 20C receives the RACH response from the base station device 10. The terminal device 20C sets information representing emergency information in the establishmentCause region in the RRC connection request. Further, the terminal device 20C stores notification data of emergency information in the spare region in the RRC connection request (Step S4).

The terminal device 20C transmits an RRC connection request to the base station device 10 (Step S5).

The base station device 10 receives the RRC connection request from the terminal device 20C. The base station device 10 acquires the emergency information from the received RRC connection request (Step S6).

The base station device 10 then sets information indicating receipt of the emergency information as a rejection reason in the Rejection cause region in the RRC connection reject (Step S7).

The base station device 10 transmits the RRC connection reject to the terminal device 20C (Step S8). The terminal device 20C receives the RRC connection reject from the base station device 10 to end the connection sequence.

The base station device 10 incorporates emergency information in the notification information (Step S9). The base station device 10 then transmits the notification information including the emergency information incorporated therein to the terminal devices 20A to 20C present in the own cell (Step S10).

The terminal devices 20A to 20C receive the notification information including the emergency information incorporated therein. The terminal devices 20A to 20C acquire the emergency information from the received notification information (Steps S11 to S13).

The terminal devices 20A and 20B decide control to be executed based on the emergency information and respectively execute autonomous control with respect to the vehicle 2 mounted therewith (Steps S14 to S15). Meanwhile, because the terminal device 20C is the source of the emergency information, the terminal device 20C ends the process without executing autonomous control.

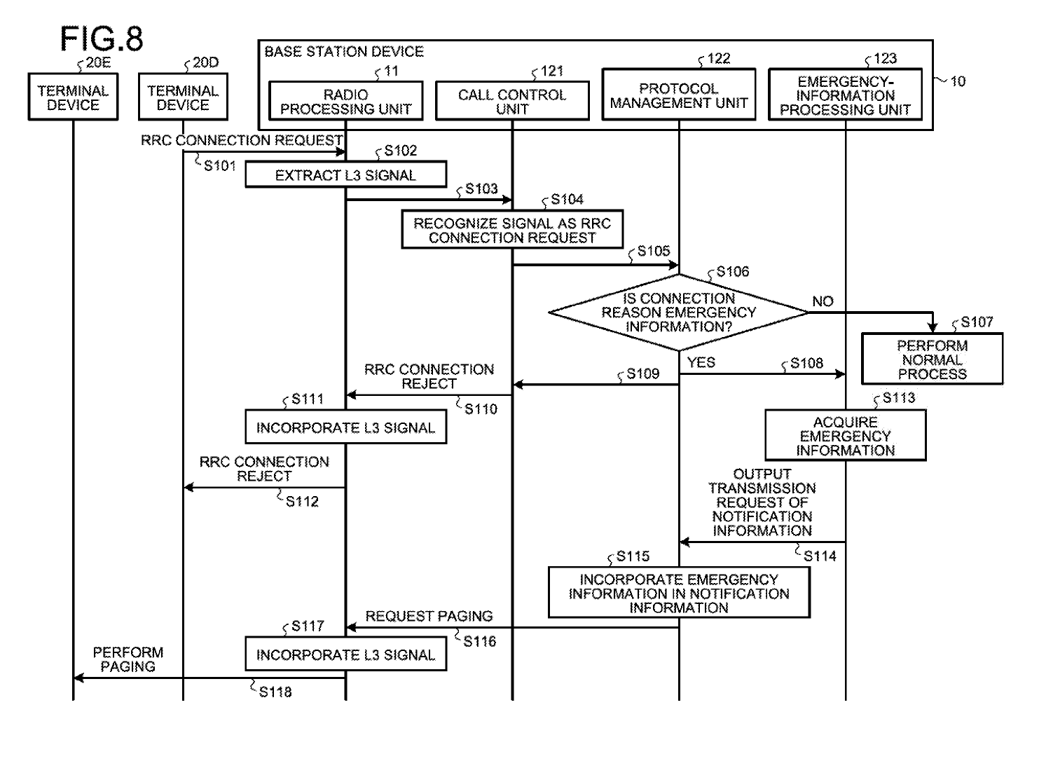

Details of a process performed by the base station device 10 in notification of emergency information will be described next with reference to FIG. 8. FIG. 8 is a sequence diagram representing the details of the process performed by the base station device 10 in notification of emergency information. A case where a terminal device 20D is the terminal device 20 that issues emergency information, and a terminal device 20E represents all other terminal devices 20 present in the cell of the base station device 10 including the terminal device 20D is described here.

The terminal device 20D transmits an RRC connection request to the radio processing unit 11 of the base station device 10 (Step S101).

The radio processing unit 11 receives the RRC connection request from the terminal device 20D. The radio processing unit 11 extracts an L3 signal from the RRC connection request as a connection request signal (Step S102).

The radio processing unit 11 outputs the L3 signal extracted from the RRC connection request to the call control unit 121 (Step S103).

The call control unit 121 receives an input of the L3 signal extracted from the RRC connection request from the radio processing unit 11. The call control unit 121 recognizes that the received L3 signal is the RRC connection request (Step S104).

The call control unit 121 outputs the L3 signal extracted from the RRC connection request to the protocol management unit 122 (Step S105).

The protocol management unit 122 receives an input of the L3 signal extracted from the RRC connection request from the call control unit 121. The protocol management unit 122 determines whether the connection reason is the emergency information based on information set in the establishmentCause region (Step S106).

If the connection reason is not the emergency information (NO at Step S106), the protocol management unit 122 performs a normal process of the connection sequence (Step S107).

On the other hand, if the connection reason is the emergency information (YES at Step S106), the protocol management unit 122 outputs the L3 signal extracted from the RRC connection request to the emergency-information processing unit 123 (Step S108).

The protocol management unit 122 generates an RRC connection reject setting the receipt of the emergency information as the rejection reason, and outputs the RRC connection reject to the call control unit 121 (Step S109).

The call control unit 121 receives the RRC connection reject from the protocol management unit 122. The call control unit 121 requests the radio processing unit 11 to transmit the RRC connection reject (Step S110).

The radio processing unit 11 receives the transmission request of the RRC connection reject from the call control unit 121. The radio processing unit 11 generates a signal notifying the RRC connection reject by incorporating the L3 signal being the RRC connection reject therein (Step S111).

The radio processing unit 11 transmits the signal notifying the RRC connection reject to the terminal device 20D (Step S112). The terminal device 20D receives the signal notifying the RRC connection reject from the radio processing unit 11. Accordingly, the terminal device 20D ends the connection sequence.

The emergency-information processing unit 123 receives an input of the L3 signal extracted from the RRC connection request from the protocol management unit 122. The emergency-information processing unit 123 acquires the emergency information from the acquired L3 signal (Step S113).

The emergency-information processing unit 123 outputs a transmission request of notification information together with the acquired emergency information to the protocol management unit 122 (Step S114).

The protocol management unit 122 receives an input of the transmission request of the notification information together with the emergency information from the emergency-information processing unit 123. The protocol management unit 122 registers information indicating presence of the emergency information in the MIB of the notification information, and stores the emergency information in the SIB representing the contents of the emergency information, thereby incorporating the emergency information in the notification information (Step S115).

The protocol management unit 122 outputs the notification information including the emergency information incorporated therein to the radio processing unit 11 via the call control unit 121 and requests paging (Step S116).

The radio processing unit 11 receives the paging request together with the notification information including the emergency information incorporated therein from the call control unit 121. The radio processing unit 11 generates a signal for notifying the notification information by incorporating the L3 signal being the notification information therein (Step S117).

The radio processing unit 11 performs paging and transmits the generated signal for notifying the notification information to the terminal device 20E, which is under control of the base station device 10 (Step S118). The terminal device 20E receives the signal for notifying the notification information. The terminal device 20E acquires the emergency information.

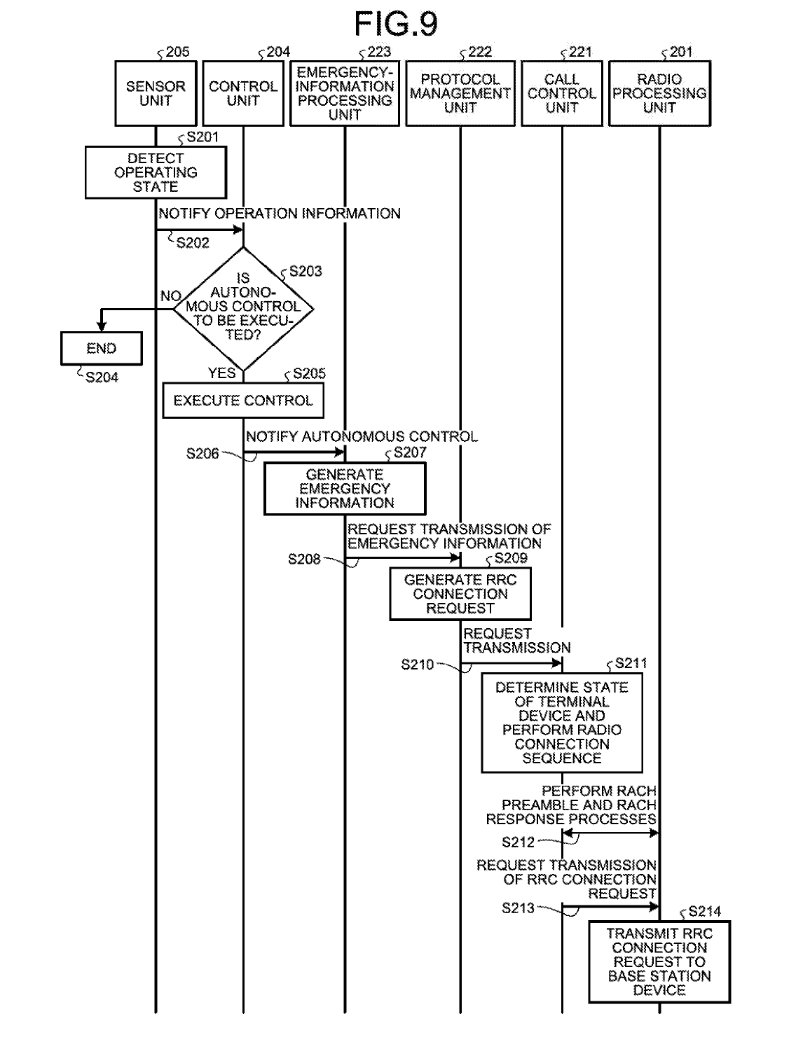

Details of a process performed by the terminal device 20 in notification of emergency information will be described next with reference to FIG. 9. FIG. 9 is a sequence diagram representing details of the process performed by the terminal device in notification of emergency information.

The sensor unit 205 detects the operating state of the vehicle 2 (Step S201). The sensor unit 205 outputs operation information of the vehicle 2 to the control unit 204 (Step S202).

The control unit 204 receives an input of the operation information of the vehicle 2 from the sensor unit 205. The control unit 204 determines whether to execute autonomous control with respect to the vehicle 2 based on the acquired operation information (Step S203). If autonomous control is not to be executed (NO at Step S203), the terminal device 20 ends the notification process of emergency information (Step S204).

On the other hand, if autonomous control is to be executed (YES at Step S203), the control unit 204 executes control with respect to the vehicle 2 (Step S205). The control unit 204 then outputs a notification of autonomous control to the emergency-information processing unit 223 (Step S206).

The emergency-information processing unit 223 receives the notification of autonomous control from the control unit 204. The emergency-information processing unit 223 generates emergency information (Step S207). Thereafter, the emergency-information processing unit 223 outputs a transmission request of the generated emergency information to the protocol management unit 222 (Step S208).

The protocol management unit 222 receives the transmission request of the emergency information from the emergency-information processing unit 223. The protocol management unit 222 generates an RRC connection request in which notification data of emergency information is stored, while setting notification of the emergency information as a connection reason (Step S209). The protocol management unit 222 outputs the transmission request of the generated RRC connection request to the call control unit 221 (Step S210).

The call control unit 221 receives the transmission request of the RRC connection request from the protocol management unit 222. The call control unit 221 determines the state of the terminal device 20 and performs a radio connection sequence (Step S211). Accordingly, the RACH preamble and RACH response processes are performed between the call control unit 221 and the radio processing unit 201 (Step S212).

Thereafter, the call control unit 221 outputs the transmission request of the RRC connection request to the radio processing unit 201 (Step S213).

The radio processing unit 201 receives the transmission request of the RRC connection request from the call control unit 221. The radio processing unit 201 transmits the RRC connection request to the base station device 10 (Step S214).

(Hardware Configuration)

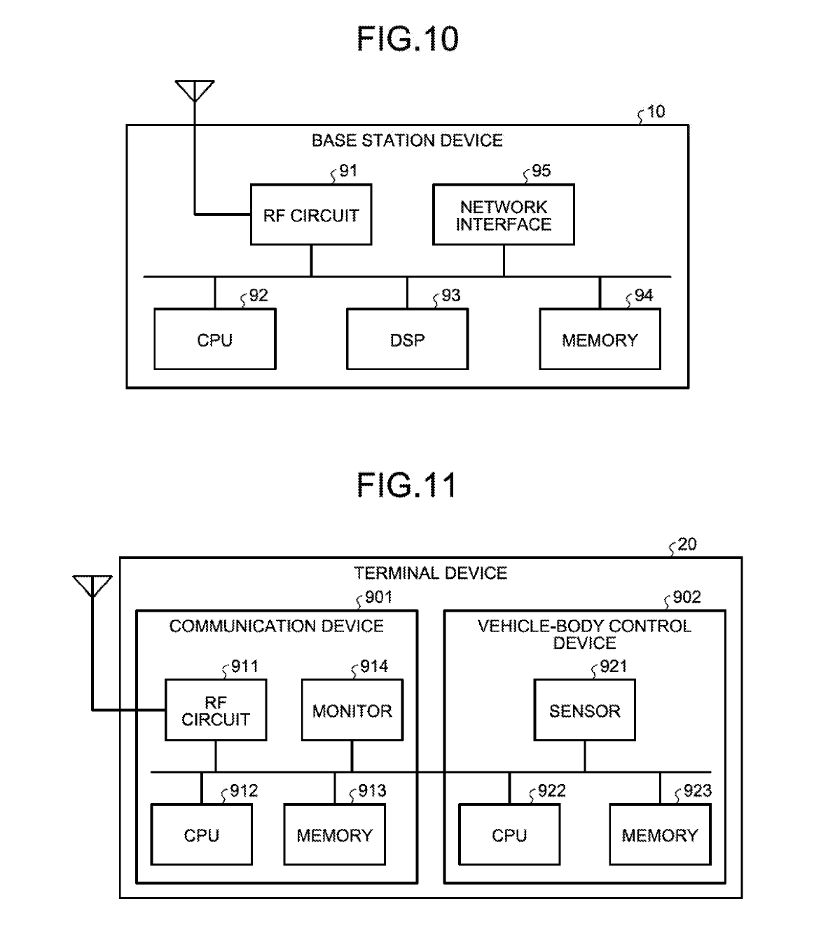

A hardware configuration of the base station device 10 is described next with reference to FIG. 10. FIG. 10 is a hardware configuration diagram of the base station device.

The base station device 10 includes, as illustrated in FIG. 10, an RF circuit 91, a central processing unit (CPU) 92, a digital signal processor (DSP) 93, a memory 94, and a network interface 95.

The CPU 92 and the DSP 93 are connected to the RF circuit 91, the memory 94, and the network interface 95 by a bus, and are connected to each other by a bus. The network interface 95 realizes the function of the network interface unit 13 illustrated in FIG. 2.

Various programs including a program for realizing the functions of the radio processing unit 11 and the communication control unit 12 illustrated in FIG. 2 are stored in the memory 94.

The RF circuit 91 and the DSP 93 realize the function of the radio processing unit 11, for example, exemplified in FIG. 2. For example, the RF circuit 91 receives a radio signal transmitted from the terminal device 20. The DSP 93 reads out and executes the various programs stored in the memory 94, for example, to perform signal processing such as encoding and decoding.

The CPU 92 reads out and executes the various programs stored in the memory 94, to realize the function of the communication control unit 12 exemplified in FIG. 2.

A hardware configuration of the terminal device 20 is described next with reference to FIG. 11. FIG. 11 is a hardware configuration diagram of the terminal device.

The terminal device 20 includes two devices, for example, a communication device 901 and a vehicle-body control device 902. The communication device 901 realizes the function of the communication management unit 21, for example, illustrated in FIG. 6. The vehicle-body control device 902 realizes the function of the vehicle-body control unit 22, for example, illustrated in FIG. 6.

The communication device 901 includes an RF circuit 911, a CPU 912, a memory 913, and a monitor 914. The monitor 914 realizes the function of the user interface unit 203, for example, exemplified in FIG. 6.

The memory 913 stores therein various programs including a program for realizing the functions of the radio processing unit 201 and the communication control unit 202 exemplified in FIG. 6.

The CPU 912 reads out and executes the various programs stored in the memory 913, to realize the functions of the radio processing unit 201 and the communication control unit 202 exemplified in FIG. 6 together with the RF circuit 911.

The vehicle-body control device 902 includes a sensor 921, a CPU 922, and a memory 923. The sensor 921 includes a speed sensor, a distance sensor, and a GPS. The sensor 921 realizes the function of the sensor unit 205 exemplified in FIG. 6.

The memory 923 stores therein various programs including a program for realizing the function of the control unit 204 exemplified in FIG. 6.

The CPU 922 reads out and executes the various programs stored in the memory 923 to realize the function of the control unit 204 such as control of the vehicle 2.

In the above descriptions, the RRC connection request and the RRC connection reject have been used in order to perform notification of information more quickly. However, if passage of time is permissible, signals other than the above can be used for notification of emergency information. For example, after an RRC connection request, an RRC connection setup is transmitted from the base station device 10 to the terminal device 20, and thereafter, an RRC connection complete is transmitted from the terminal device 20 to the base station device 10. After this, the base station device 10 and the terminal device 20 are in a connected state to each other.

Therefore, for example, the terminal device 20 can notify the emergency information by using the RRC connection complete. If it is after connection between the base station device 10 and the terminal device 20, the terminal device 20 can post the emergency information on a UL information transfer signal. The process until the connection after the RRC connection request is established is an example of a “series of processes for establishing connection”, and a signal used for the processes is an example of a “signal for connection establishment”.

As described above, in a mobile communication system according to the present embodiment, a base station device receives information transmitted from one terminal device and notifies terminal devices under control thereof of the received information. Thus, by notifying the other terminal devices of information transmitted from the one terminal device via the base station device, delay in the network can be suppressed as compared to a case where information is transmitted via a data server, and delay due to repeating of vehicle-to-vehicle communication can be suppressed. Therefore, quick information sharing can be achieved by the mobile communication system according to the present embodiment and the performance of automatic driving can be improved.

For example, when an automobile travels at a speed of 40 kilometers per hour, the vehicle travels about 11 meters per second. Therefore, if a distance between vehicles traveling at a speed of 40 kilometers per hour is, for example, 3 to 5 meters, a reaction speed equal to or lower than 500 milliseconds is desired in order to avoid collision by autonomous control. Generally, when communication is performed between a terminal device and a data server present on the Internet at a position farther away than the base station device, it can be considered that a response is returned in an order of close to a unit of second. Further, if congestion occurs in the network, the delay time fluctuates and it is difficult to ensure a prompt response. Therefore, when information is notified via communication with the data server, it is difficult to avoid collision due to autonomous control under the conditions described above.

Further, it is considered that autonomous control based on operation detection by an on-board sensor requires time in an order of 100 milliseconds. According to the mobile communication system of the present embodiment, the time spent for notification of emergency information is several tens milliseconds even if a processing time for arranging the signal by the base station device is added, because communication of signals in a radio section for information notification can be performed in one millisecond. The emergency information can be notified to other terminal devices in an order of several tens milliseconds. Therefore, even if an elapsed time in an order of 100 milliseconds due to the autonomous control described above is added to the notification time of information in the mobile communication system according to the present embodiment, the response time can fall within the reaction speed described above. Further, because there is no delay cause due to congestion or the like and no fluctuation of delay time, information can be notified reliably within a short period of time, and reliable automatic driving can be realized.

According to one aspect of the base station device, the terminal device, the mobile communication system, and the control method for a mobile control system disclosed in the present application, the performance of automatic driving can be improved.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

1. A base station device that receives a signal for connection establishment between a terminal device and the base station device from the terminal device and performs series of processes for the connection establishment, the base station device comprising:
a processor configured to:
receive the signal for the connection establishment transmitted from the terminal device;
acquire predetermined information, when the predetermined information is stored in the signal for the connection establishment received;
store notification information indicating presence of the predetermined information in a Master Information Block (MIB) of a notification signal and store the predetermined information acquired in a System Information Block (SIB) of the notification signal; and
transmit the notification signal to at least another terminal device other than the terminal device.

2. The base station device according to claim 1, wherein
the processor is configured to receive the signal for the connection establishment including a radio-resource-control connection request, and
when the predetermined information is stored in the radio-resource-control connection request, acquire the predetermined information.

3. The base station device according to claim 2, wherein the processor is configured to, when the predetermined information is stored in the radio-resource-control connection request, transmit a signal indicating rejection of establishment of connection to the terminal device.

4. The base station device according to claim 1, wherein the processor is configured to store notification information indicating presence of the predetermined information in the notification signal together with the predetermined information.

5. The base station device according to claim 1, wherein the processor is configured to transmit the notification signal also to the terminal device.

6. A terminal device that transmits a signal for connection establishment between the terminal device and a base station device and performs a series of processes for the connection establishment, the terminal device comprising:
a processor configured to:
store, upon detection of occurrence of a predetermined event, predetermined information in the signal for connection establishment and transmit the signal to the base station device which has a processor configured to receive the signal for the connection establishment transmitted from the terminal device, acquire predetermined information, when the predetermined information is stored in the signal for the connection establishment received, store notification information indicating presence of the predetermined information in a Master Information Block (MIB) of a notification signal and store the predetermined information acquired in a System Information Block (SIB) of the notification signal, and transmit the notification signal to at least another terminal device other than the terminal device.

7. A mobile communication system including a terminal device and a base station device that transmit and receive a signal for connection establishment to and from each other and perform a series of processes for the connection establishment, wherein
the terminal device includes a first processor configured to store, upon detection of occurrence of a predetermined event, predetermined information in the signal for the connection establishment and transmit the signal to the base station device, and
the base station device includes a second processor configured to:
receive the signal for the connection establishment transmitted from the terminal device,
acquire the predetermined information, when the predetermined information is stored in the signal for the connection establishment received,
store notification information indicating presence of the predetermined information in a Master Information Block (MIB) of a notification signal and store the predetermined information acquired in a System Information Block (SIB) of the notification signal; and
transmit the notification signal to at least another terminal device other than the terminal device.

8. A control method for a mobile communication system including a terminal device and a base station device that transmit and receive a signal for connection establishment to and from each other and perform a series of processes for the connection establishment, wherein the control method
causes the terminal device to store predetermined information in a signal for the connection establishment and transmit the signal to the base station device, upon detection of occurrence of a predetermined event,
causes the base station device to receive the signal for the connection establishment transmitted from the terminal device,
causes the base station device to acquire the predetermined information, when the predetermined information is stored in the received signal for the connection establishment,
causes the base station device to store notification information indicating presence of the predetermined information in a Master Information Block (MIB) of a notification signal and to store the predetermined information acquired in a System Information Block (SIB) of the notification signal, and
causes the base station device to transmit a notification signal to at least another terminal device other than the terminal device.
